(19) United States
(12) Patent Application Publication
(10) Pub. No.: US 2010/0185515 A1
(43) Pub. Date: Jul. 22, 2010

(54) ALLOCATION OF INTERNET ADVERTISING INVENTORY

(75) Inventors: Ramana Yerneni, Cupertino, CA (US); Erik Vee, San Mateo, CA (US); Minos Garofalakis, Chania -Crete (GR); Srinivasan Rajagopal, San Jose, CA (US); Jayavel Shanmugasundaram, Santa Calra, CA (US); Mark Sordo, Santa Cruz, CA (US); Donald Swanson, Mountain View, CA (US); Sergei Vassilvitskii, New York, NY (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/355,282

(22) Filed: Jan. 16, 2009

(51) Int. Cl. G06Q 30/00; G06Q 10/00; G06Q 90/00

(52) U.S. Cl. 705/14.58; 705/28; 705/14.66

(57) ABSTRACT

A method and system for allocating inventory in an Internet environment is provided. A method employed by the system may include generating an inventory pool that represents a number of impressions deliverable to all users, then determining, from multiple past orders for booking impressions, a hierarchy of parameters utilized to target users and a number of impressions deliverable to users characterized by the parameters. The inventory pool may then be partitioned into multiple inventory pools according to the hierarchy, where each inventory pool represents a number of impressions deliverable to users characterized by parameters associated with the inventory pool. The hierarchy of pools may then be stored to a database.

### RELATED APPLICATION

This application is related to U.S. patent application Ser. No. ______, assigned attorney docket No. 12729-526; U.S. patent application Ser. No. ______, assigned attorney docket No. 12729-527; and U.S. patent application Ser. No. ______, assigned attorney docket No. 12729-528, all of which are filed on even date herewith and hereby incorporated by reference in their entirety.

### BACKGROUND

The Internet has emerged as a powerful advertising tool. It is commonplace to see advertisements on many web sites. For example, advertisements may be displayed on search web sites and may be targeted to individuals based upon search terms provided by the individuals. Other web sites, such as news and sports web sites, may provide space for advertisements. The owners of these web sites may sell advertising space to advertisers to offset the costs associated with operating the web sites as well as to turn a profit.

In some cases, advertisers may wish to show their respective advertisements on a particular web site. Other advertisers may be less interested in specific web sites and more interested in displaying advertisements across several web sites that cater to a specified target audience. For example, an automobile advertiser may want an automobile advertisement displayed on web sites that relate to automobiles and racing.

To facilitate advertisement placement, web site operators may provide systems that allow the advertiser to book a number of impressions across web sites that target the specified audience, where each impression corresponds to the display of an advertisement to an Internet user. For example, the system may enable an advertiser to book 1 million impressions that target males in California. These impressions may then be allocated across several web sites that target males in California.

The number of impressions available for booking may be related to the number of impressions that were available in the past. A web site operator may use information from the past to forecast or make predictions about the number of impressions that may be available for future booking. The number of past impressions may be determined by tracking activity on the respective web sites. For example, the web site operator may track the number of visits a given web site receives. The web site operator may also keep track of the actual users that visit the web site by requiring users to register and log into the web site before utilizing the services of the web site. The data collected may be arranged within various pools of impression inventory where each pool represents a number of impressions that target a specific audience. For example, a given pool may represent 1 million impressions that target males in California, who are sports enthusiasts with a common zip code, and who viewed advertisements via a specific web site. When forecasting future impression inventory it may be necessary for a web site operator to search through various pools so as to determine whether there is enough inventory to satisfy an advertiser's order.

However, as the number of web sites available for advertising has increased, so too have the number of pools that have to be searched. The increase in the number of pools requires increased resources, such as additional storage to keep track of all the pools. In addition, the time needed to search for inventory has increased as it takes more time to search through all the pools. This increase in time leads to frustration on the part of the advertiser and possible loss of revenue to the web site operator if the advertiser chooses to book impressions through a different web site operator.

### BRIEF DESCRIPTION OF THE DRAWINGS

FIG. 1 is a system for booking impressions from pools that represent collections of impressions;

FIG. 2 is representation of various raw pools that may be stored in the raw pool database of the system in FIG. 1;

FIG. 3 illustrates information utilized to characterize a raw pool;

FIG. 4a is a flow diagram of operations for generating pools that represent forecastable impression inventory;

FIG. 4b illustrates the way in which the forecastable impression inventory is represented;

FIG. 5a is a flow diagram of operations for generating a hierarchy of pools that represent impression inventory;

FIG. 5b-FIG. 5d illustrate the hierarchy of the pools in FIG. 5a;

FIG. 6a is a flow diagram of operations for generating a lattice structure of pools that represent impression inventory;

FIG. 7 illustrates an exemplary pool lattice structure generated in accordance with FIG. 6a;

FIG. 8 illustrates one way for handling contention between pools in the lattice structure of FIG. 7;

FIG. 9a is a flow diagram of operations for adding a new pool into the pool lattice structure of FIG. 7;

FIG. 9b-FIG. 9d illustrate the redistribution of inventory between existing pools and new pools added in accordance with FIG. 9a;

FIG. 10a is a flow diagram of operations for generating a set of representatives that represent Internet users;

FIG. 10b is a flow diagram for optimizing cushions associated with the contracts generated according to FIG. 10a;

FIG. 11 is a flow diagram of operations for generating a tiered representation of impression inventory;

FIG. 13 illustrates the two-tiered hierarchy generated in accordance with FIG. 11; and

FIG. 14 illustrates a general computer system, which may represent any of the computing devices referenced herein.

### DETAILED DESCRIPTION

The embodiments below describe systems for allocating impression inventory. Generally, impression inventory is organized into a structured group of impression inventory pools. The pools are structured so as to enable quickly determining an amount of available inventory. This in turn enables an advertiser to book an order for impressions in a shorter time than would otherwise be possible.

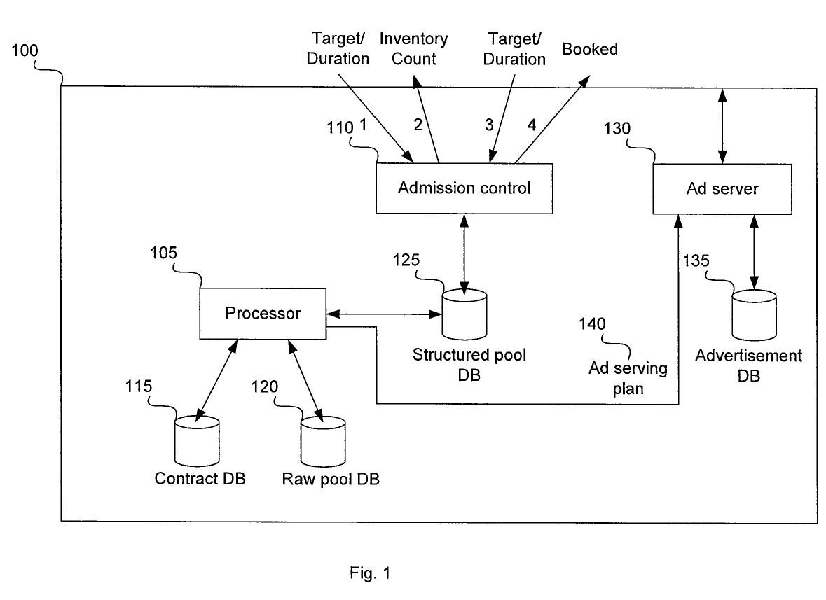

FIG. 1 is a system 100 for booking impressions from pools that represent collections of impressions. The system 100 includes an admission control subsystem 110, a contract database 115, a raw pool database 120, and a structured pool database 125. The various components of the system 100 may reside on a single computer or be distributed between several computers interconnected by a communication network.

The processor 105 may correspond to an Intel®, AMD®, or PowerPC® based processor operating a Microsoft Windows®, Linux, or other Unix® based operating system. The processor 105 may be adapted to communicate data to and from the contract database 115, raw pool database 120 and/or structured pool database 125. The processor 105 may be adapted to communicate with other computers via an interface, such as a network interface. The processor 105 may also be adapted to generate a structured representation of the available impression inventory in the raw pool database 120 and store the structured representation into the structured pool database 125. In some embodiments, the structure of the pool is based on past contracts stored in the contract database.

The contract database 115, raw pool database 120, and structured pool database 125 may correspond to data storage devices suitable for storing large amounts of information, such as RAM, ROM, or hard disk drives. The contract database 115 stores information related to past contracts for booking impressions between advertisers and web site operators. The contract information may include information specified in the contracts entered into between the web site operators and advertisers, such as target audience information, the number of impressions booked, the time over which the impressions were booked, and the amount paid for booking the impressions.

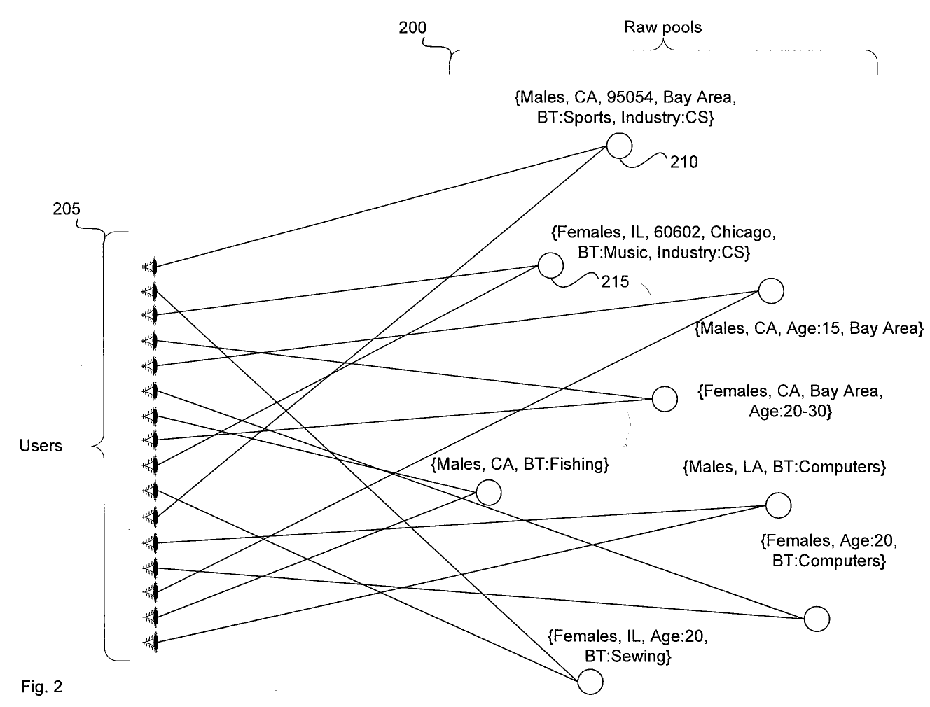

The raw pool database 120 stores information related to various pools that represent impression inventory. FIG. 2 is representation of various raw pools 200 that may be stored in the raw pool database 120. Referring to FIG. 2, each raw pool 200 represents the number of impressions available that target a specific audience of users 205 that share certain attributes. For example, a first raw pool 210 may represent the number of impressions available to males from the Bay area in California who have the zip code 95054 and are sports enthusiasts. A second raw pool 215 may represent the number of impressions available to females that live in Chicago, Ill., who have the zip code 60602 and are music enthusiasts.

The number of impressions available within a raw pool may be based on the number of past impressions delivered to users with known characteristics. This number may be determined by tracking activity on the web sites that host advertising. For example, web site operators may track the number of visits a given web site receives. The web site operator may also keep track of the actual users that visit the web site by requiring the users to register and log into the web site before utilizing the services of the web site.

The size of a raw pool varies with the number of impressions it represents. For example, a raw pool that represents the number of impression available to individuals that live in a very small city may be smaller than a raw pool that represents the number of impressions available to users that live in a large city. The larger the pool, the more forecastable the size of the pool. That is, the larger the pool the more easy it may be to predict the size of the pool on a future date.

Generally, the more fine grained or specified the raw pool, the fewer the number of impressions available. For example, the size of a raw pool that represents the number of impressions viewed by males may be larger than the size of a raw pool that represents the number of impressions viewed by males from a particular state, who have a given hobby.

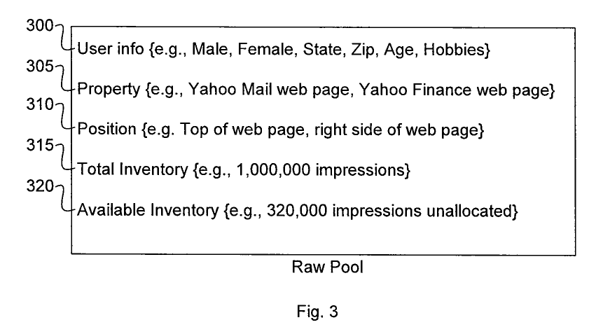

FIG. 3 illustrates information utilized to characterize a raw pool. Information associated with each raw pool may include user information 300, property information 305, position information 310, total inventory information 315, and available inventory information 320. The user information 300 includes data that defines characteristics of the users associated with the impressions represented in the pool. For example, the user information 300 may include the sex, age, and geographic information associated with the users. The property information 305 defines the web site or web page to which impressions are delivered. For example, the property information 305 may correspond to a sponsored search web site, such a Yahoo! Search ®, or email web site, such as Yahoo! Mail®.

The position information 310 corresponds to the location of the advertisements on the web pages above. For example, the position information 310 may indicate that the impressions are to be delivered via a region at the top, bottom or side of a web page.

The total inventory information 315 corresponds to the number of impressions that the raw pool represents before booking and the available inventory information 320 corresponds to the number of impressions available for booking.

Referring back to FIG. 1, the structured pool database 125 stores data that defines a structured representation of the available impression inventory. Generally, the structured representation is a collection of impression inventory pools organized so as to enable quickly determining the number of impressions available for booking. Each pool may be defined by the information described above with reference to FIG. 3.

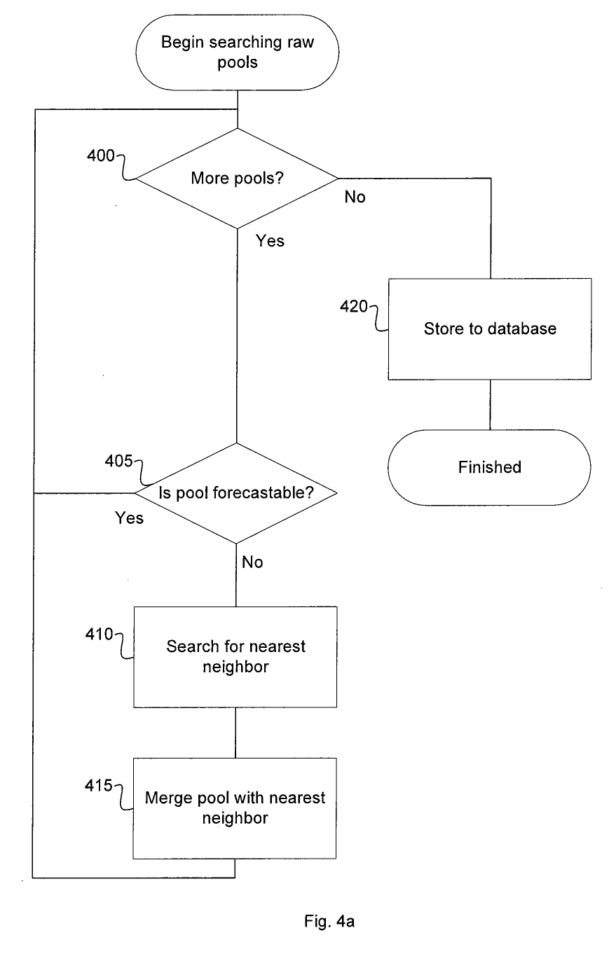

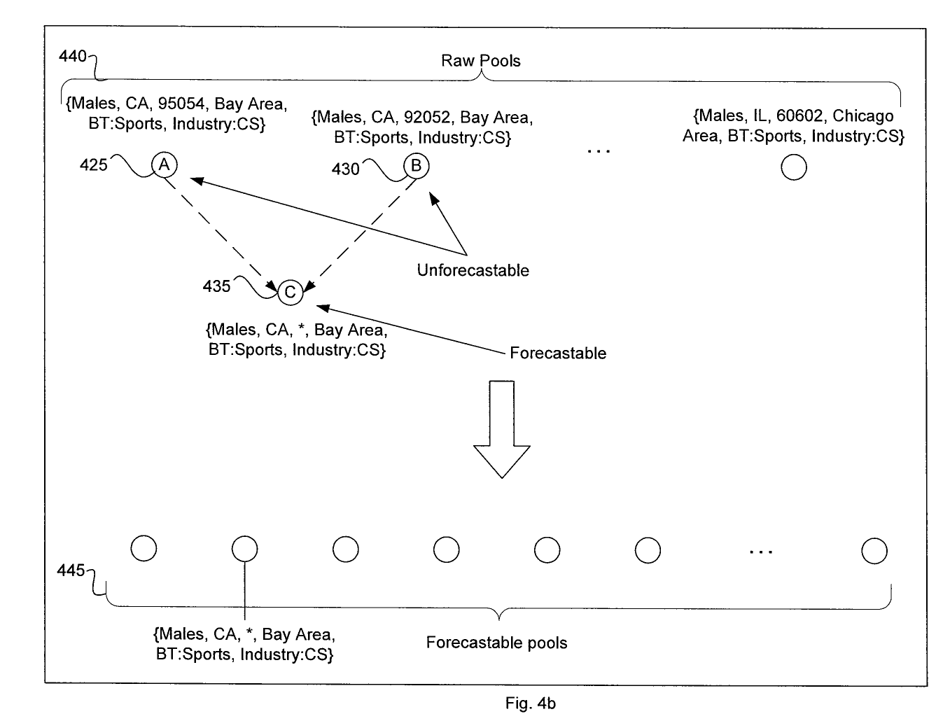

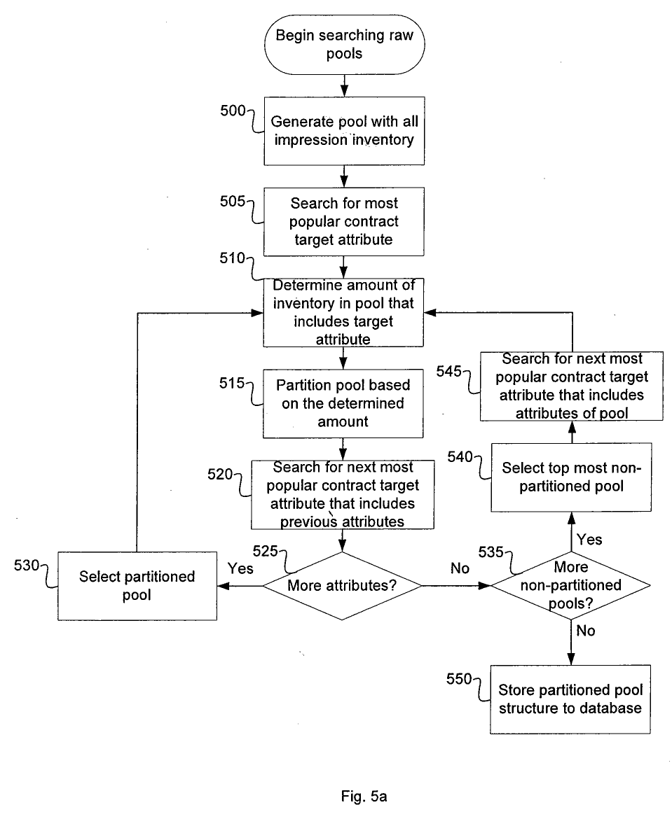

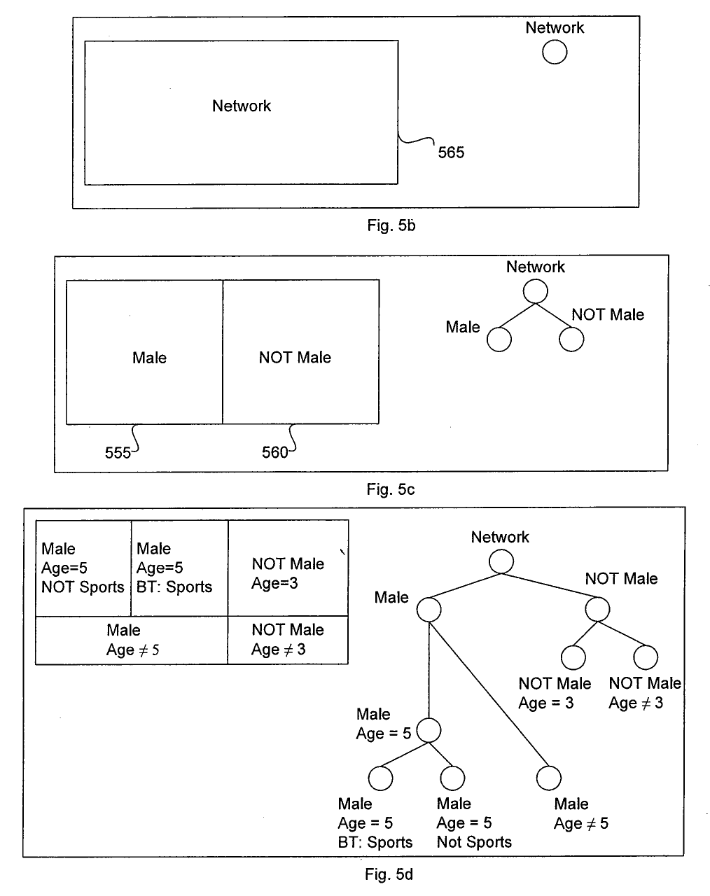

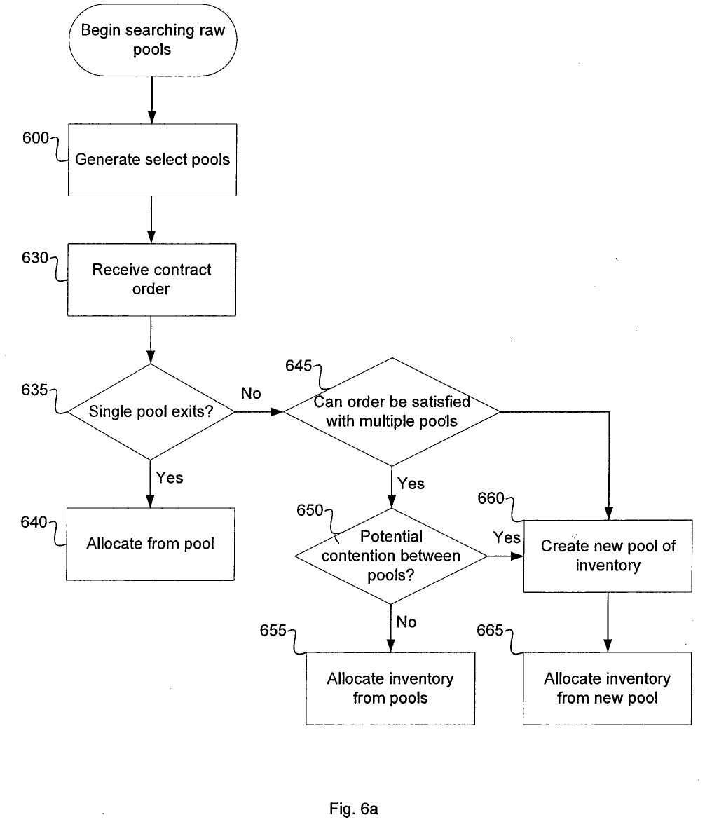

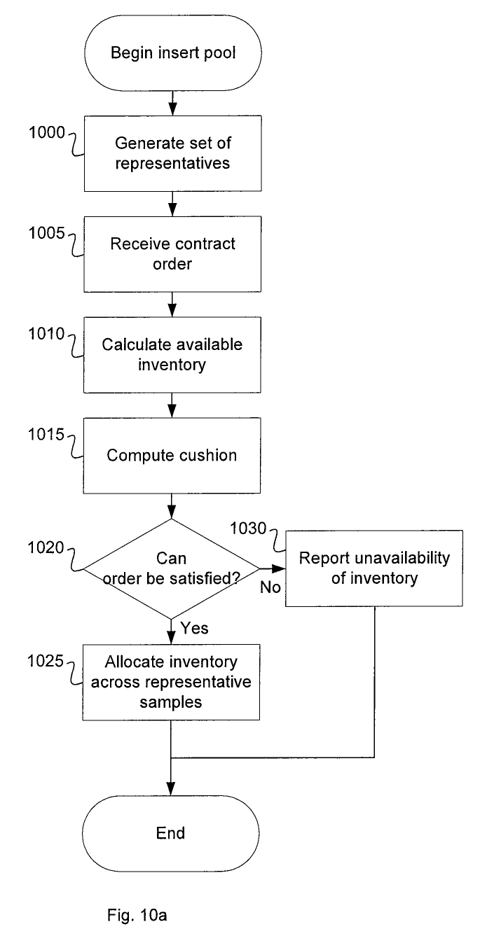

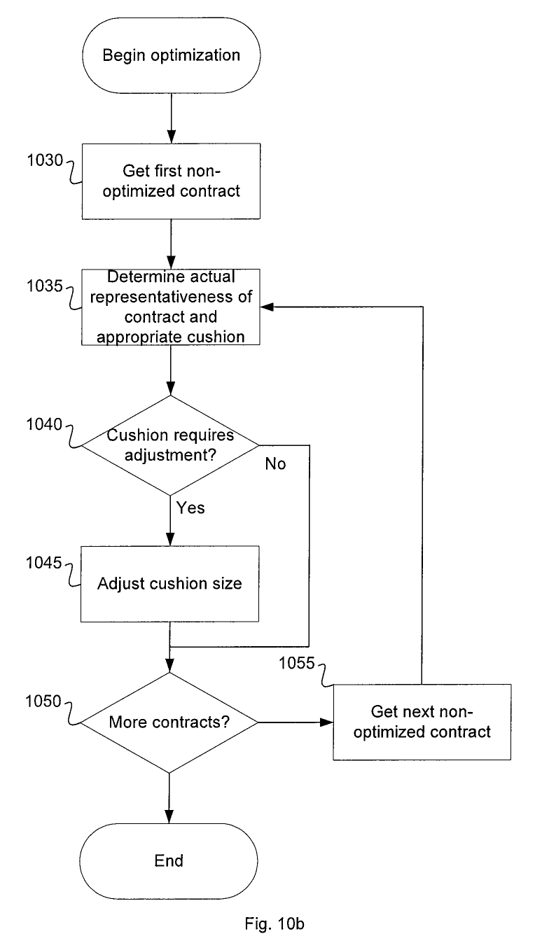

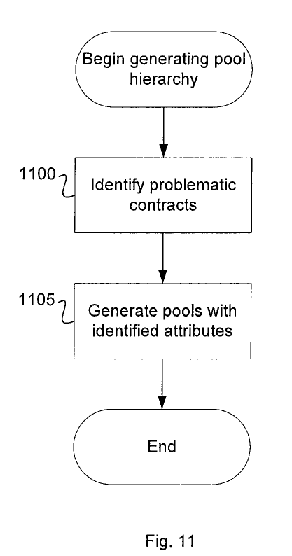

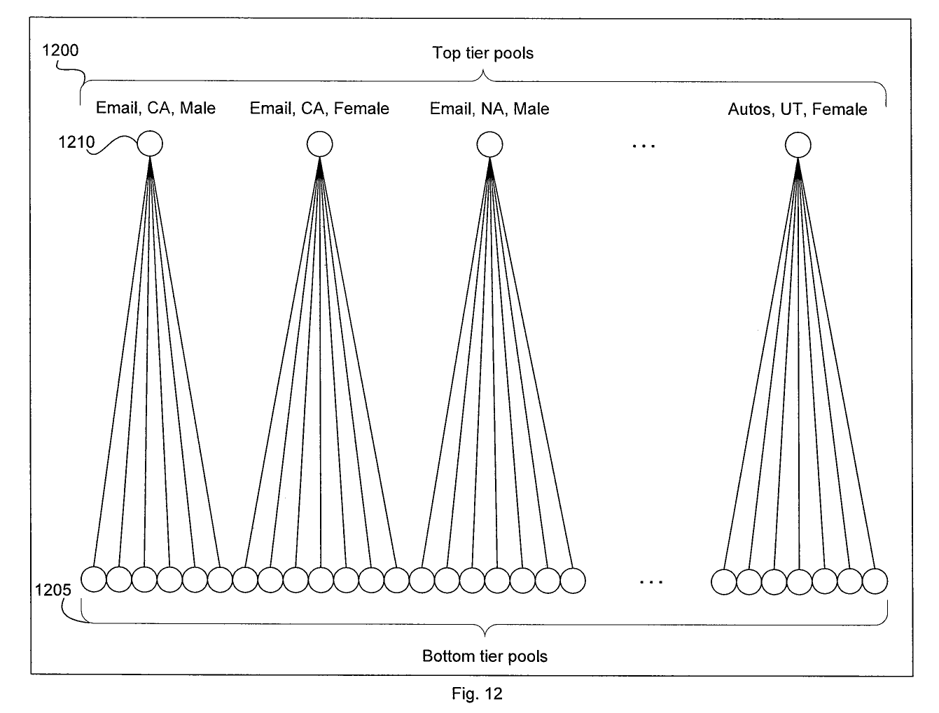

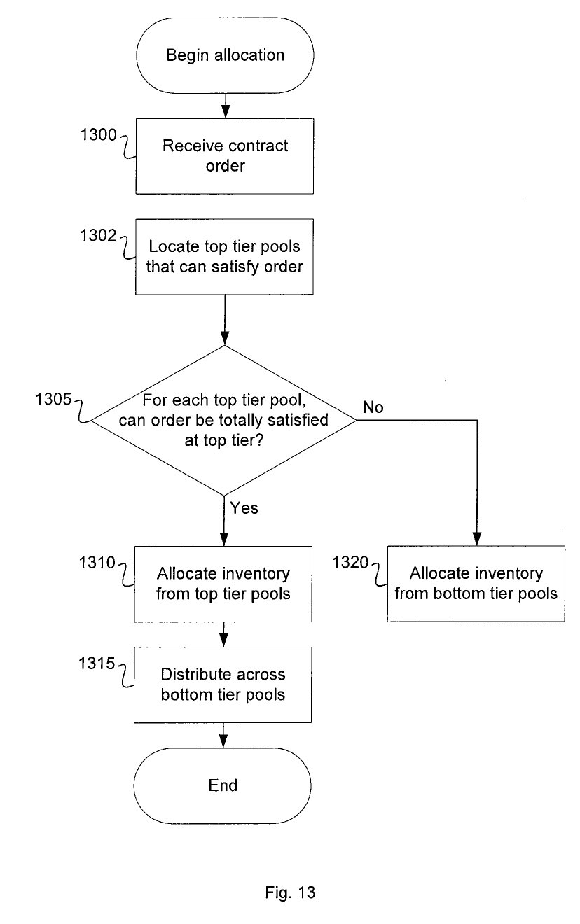

The pools in the structured pool database 125 may be organized in various ways. For example, in a first embodiment, impression inventory may be represented by pools that represent forecastable impression inventory, as described in FIG. 4a and FIG. 4b below. In a second embodiment, impression inventory may be represented via a hierarchy of pools of impressions, as described in FIG. 5a-FIG. 5d below. In a third embodiment, the impression inventory may be represented via a lattice structure of pools, as described in FIG. 6a-FIG. 9d below. In a fourth embodiment, the impressions may be represented by representatives, as described in FIG. 10a and FIG. 10b below. Finally, in a fifth embodiment, impression inventory may be represented via a two-tiered hierarchy, as described in FIG. 11 and FIG. 13 below.

The admission control subsystem 110 may include logic, circuitry, and/or code that enables booking orders from available impression inventory. To facilitate booking, the admission control subsystem 110 may be adapted to communicate a web page to advertisers that allows advertisers to specify the parameters associated with the order. For example, the web page may enable specifying the quantity of impressions sought along with information that defines the target audience to whom the impressions are to be delivered. In addition, the web page may enable specifying the desired property or properties where the advertiser may wish to place an advertisement, along with a desired position on the property where the advertisement may be shown.

After receiving the order, the admission control subsystem 110 searches through the structured pool database 125 for impression inventory that matches the order. After determining the quantity of available impressions, the admission control subsystem 110 communicates the available quantity back to the advertiser along with a price associated with booking the impressions. The price may be related to the scarcity of the impression inventory. For example, the price per impression may decrease as the availability of the inventory of impressions increases.

Upon receiving the quantity of available impressions, along with the price per impression, the advertiser may elect to book the impressions. Once booked, the admission control subsystem 110 allocates the inventory from the pools identified in the structured pool database 125.

Allocating impressions from the structured pool database 125 may be significantly faster than allocating impressions from the raw pools, because the pools are structured in such a way as to enable quickly determining and booking a desired number of impressions deliverable to a target audience specified in an order. Eventually, however, the impression allocations made from the structured pool database 125 may be distributed to the raw pools stored in the raw pool database 120. This may occur at a time different than when the impressions are booked. For example, this may occur during periods of time when the system 100 is lightly loaded, such as 1 AM on Sunday. Initially allocating from the structured pool database 125 and then from the raw pools in the raw pool database 120 enables quick and accurate forecasting and booking of impression inventory.

Alternatively, the allocation decisions need not be made. For example, when the system is confident that there are enough available impressions for each contract, the specific decision of which impressions from the raw pool database 120 to serve to each contract may be made at serving time.

The information stored in the structured pool database 125 may be utilized to generate an ad serving plan 140. The ad serving plan 140 may be generated by the processor 105 and communicated to an ad server 130. The ad server may correspond to a device similar to the processor 105 described above. The ad server 130 may utilize information in the ad serving plan 140 to direct advertisements associated with the contracts specified above to appropriate opportunities as they arrive, where an opportunity corresponds to a user viewing a web page for which there is place for an advertisement. For example, a given contract may have requested impressions associated with females. Impressions associated with females may have been allocated from various pools in the structure pool database 125 that represent females, to the contract. This information may be included in the ad serving plan 140. When an opportunity that corresponds to a female viewing a web page arrives at the ad server 130, the ad server may retrieve an advertisement associated with the contract from an advertisement database 135 and serve the advertisement to the web page that the female is viewing.

FIG. 4a-FIG. 13 describe various way in which pools in the structured pool database 125 may be organized. The operations described below may be carried out by the processor 105 of the system 100 of FIG. 1.

FIG. 4a is a flow diagram of operations for generating pools of forecastable impression inventory. FIG. 4b illustrates the way in which the forecastable impression inventory is represented. How forecastable a pool is may depend on the size of the pool. For example, referring to FIG. 4b, raw pool A 425 and raw pool B 430 may be unforecastable because they represent too small a pool of impressions. In this example, the pools may be small because they only target males that live within a specific zip code. The threshold of forecastability of a raw pool may be based on the minimum size that the raw pool has maintained over a given period of time. For example, if a raw pool has fluctuated between 100,000 impressions and 1,000,000 impression over the course of the year, then it may be relatively safe to assume that the raw pool will have at least 100,000 impressions available over the next year. On the other hand, if the size of the raw pool has dipped to single digit impressions, during the course of the year, the chances that no impressions are available in the next year are relatively high. In this case, the pool may not be forecastable. Other metrics may also be considered. For example, the average number of impressions along with the standard deviation in the number of impressions may be taken into account. Other statistical and forecasting methods may be also be utilized to determine whether the forecast is reliable enough.

The operations in FIG. 4a may be executed by the system 100 of FIG. 1. The operations begin at block 400 by determining whether there are raw pools 440 left to analyze. If there are more raw pools available to analyze then at block 405, a determination is made as to whether the next raw pool available is forecastable. If at block 405, a raw pool is not forecastable, then at block 410, the pool may be merged with a “nearby” pool. How near a pool is to another pool may be determined by comparing the parameters by which the pools are characterized, as described above with reference to FIG. 3. The more parameters that the pools share, the nearer the pools are to one another. For example, referring to FIG. 4b, unforecastable raw pool A 425 and raw pool B 430 both target males from California, who live in the Bay area, who are sports enthusiast. But raw pool A 425 and raw pool B 430 target different zip codes. In this case, raw pool A 425 and raw pool B 430 may be merged into new pool C 435 that targets males from California who live in the Bay area, who are sports enthusiast. The zip code parameter is no longer utilized. Pool C may be forecastable because the number of impressions in pool C 435 is the sum of the impressions in raw pool A 425 and raw pool B 430, which in this example may be large enough to forecast.

After the pools are merged then at block 400 of FIG. 4a, if more pools are available the process repeats. Otherwise, after all the pools are analyzed and the unforecastable pools combined into forecastable pools, at block 420, data representing the forecastable pools 445 is stored to a database, such as the structured pool database 125 of FIG. 1.

One advantage of the approach described in FIG. 4a and FIG. 4b is that it reduces the number of pools the admission control subsystem 110, of FIG. 1, has to search through, thus enabling the admission control subsystem 110 to determine the amount of available inventory in less time. For example, in some cases, there may be as many as 7 Million raw pools 440 available for each day of the year. However, it may be shown that approximately 40% of those pools may be too small to forecast. That is, the number of impressions that may be available in those pools may be too small to predict a future number of impressions in that pool. The approach above reduces the number of pools that have to be searched by approximately 60%. This in turn enables the admission control subsystem 110 to determine the amount of available inventory in less time that it would take to make the same determination from the raw pools of impression inventory, which in turn enables an advertiser to book impressions more quickly.

FIG. 5a is a flow diagram of operations for generating a hierarchy of pools that represent impression inventory. FIG. 5b-FIG. 5d illustrate the ways in which the impressions are represented. At block 500, all the inventory in each of the raw pools is represented by one large pool 565 as shown in FIG. 5b. That is, the large pool 565 represents all the available inventory of impressions.

At block 505, past contracts between the web site operator and advertisers may be analyzed so as to identify the most commonly specified parameter that advertisers specified in booking impressions in the past. For example, referring to FIG. 1, the processor 105 may retrieve and analyze contracts stored in the contract database 115 so as to determine the most commonly specified parameter in the contracts. For instance, the most commonly specified attribute may be the gender, male or female, of the individual to whom the impressions were delivered.

At block 510, raw pools that represent commonly specified parameters are identified and the total amount of available inventory in the identified raw pools is determined. For example, if the most commonly specified parameter is “males” and 10 raw pools, each with 1 million impressions deliverable to males, are identified, then the total number of impressions available that target males is 10×1 million, or 10 Million.

At block 515, the large pool 555 of FIG. 5b is partitioned into a portion of impressions that is viewable based on the parameter identified above and a portion of impressions that are not viewable based on the parameter above. For example, referring to FIG. 5C, if the most commonly specified attribute is “male”, then the pool is partitioned into two pools, a pool that represents males 555 and a pool that represents everything, but males 560.

At block 520, contracts that included the previously identified attribute are analyzed so as to determine the next most frequently specified targeting parameter. If at block 525, another parameter is identified, then at block 530, the pool that represents the previously identified attribute is selected, and the process repeats from block 510. For example, referring to FIG. 5d, the next most frequently ordered targeting parameter after “males” may be the age of the males, such as 5 years of age. As a result, pools are added below the male pool, one for males that are 5 years old and another for males that are not 5 years old.

If at block 525, no more attributes are identified, then at block 535, if there are pools that have yet to be partitioned, then at block 540 the remaining pools may be selected.

At block 545, contracts that include the previously identified parameter are analyzed so as to determine the next most frequently specified attribute. Then at block 510, the process repeats.

At block 535, if all the pools have been partitioned, then at block 550, data representing the partitioned pools is stored to a database, such as the structured pool database 125, of FIG. 1.

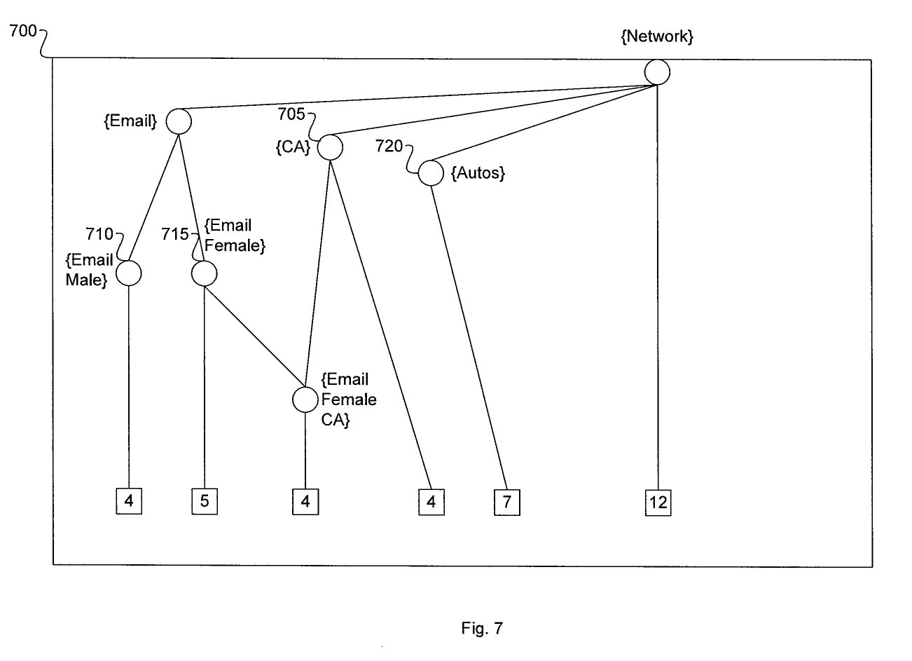

FIG. 6a is a flow diagram of operations for generating a lattice structure of pools that represent impression inventory. At block 600, an initial group of pools that represent impression inventory may be generated. Each pool may represent impressions that are deliverable to individuals with commonly sought after attributes. For example, referring to FIG. 7, a California impression pool 705 that represents impressions deliverable to individuals in California may be generated. Other pools, such as an email/male impression pool 710 and an email/female impression pool 715, may represent impressions that may be delivered to males and females, respectively, via email programs, such as Yahoo! Mail®. An automobile impression pool 720 may represent impressions associated with automobiles. The targeting attributes selected may be based on past contracts between a web site operator and advertisers and may have been determined via operations described above with reference to FIG. 4a and FIG. 4b. The number of impression represented by each of the pools may have been determined previously by searching through all the raw pools for impression inventory that matches the target parameters of the generated pools. Data that defines the generated pool may be stored in a database, such as the structured pool database of FIG. 1.

At block 630, a contract order for booking impressions may be received. For example, a web page for specifying an order may be communicated to an advertiser from, for example, the admission control subsystem 110, of FIG. 1. The web page may enable specifying the quantity of impressions sought along with information that defines the target audience of the impressions. In addition, the web page may enable specifying the desired property or properties where the advertiser may wish to place an advertisement, along with a desired position on the property where the advertisement may be shown.

At block 635, the pools generated at block 600 may be searched so as to locate impression inventory that matches the impressions in the order. For example, the admission control subsystem 110 may search through the pools stored in the structured pool database 125 for available impression inventory.

If at block 635, a single pool is found that represents impressions characterized by parameters specified in the order, then at block 640, the impressions ordered are allocated from that pool. For example, if the order only specifies California impressions, then impressions are allocated from pools that represent California impressions, such as the California impression pool 705, of FIG. 7.

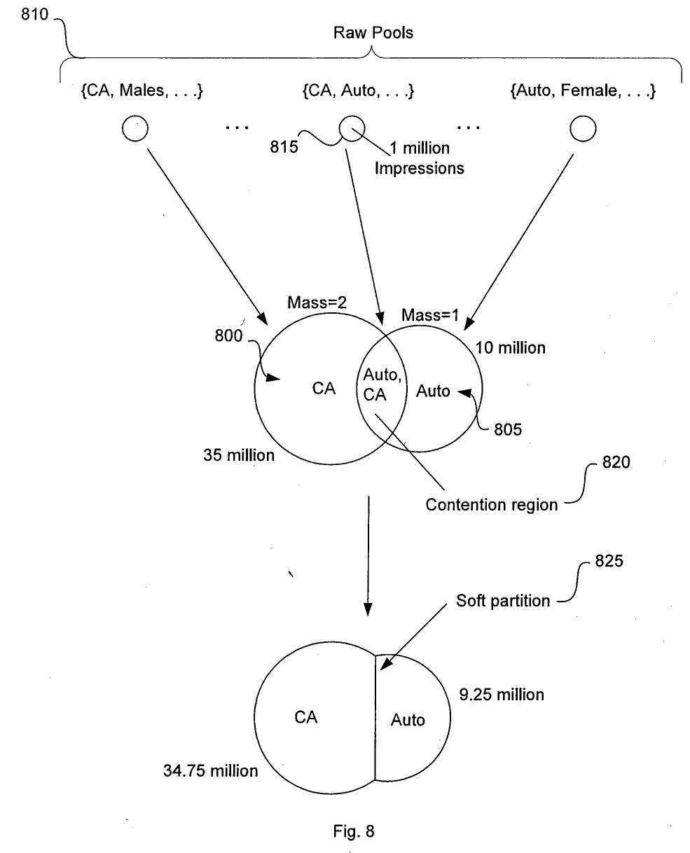

If at block 635, a single pool cannot be found, then at block 645, if multiple pools exist that include the ordered impression inventory, and if at block 650, the probability of contention between the pools is low, then impression inventory is allocated from the pools at block 655. Contention between pools may occur where the number of impressions in an order approaches the number of impressions available in the pools. Contention is explained in more detail in FIG. 8 below.

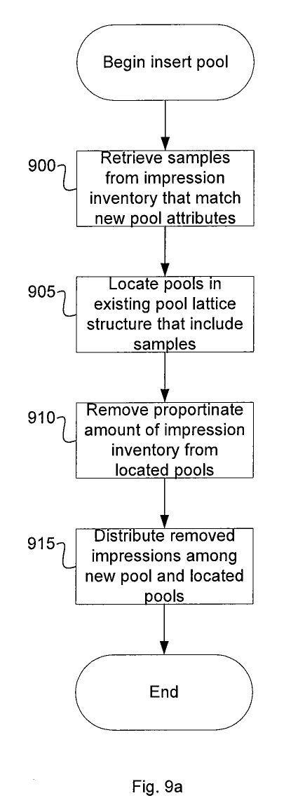

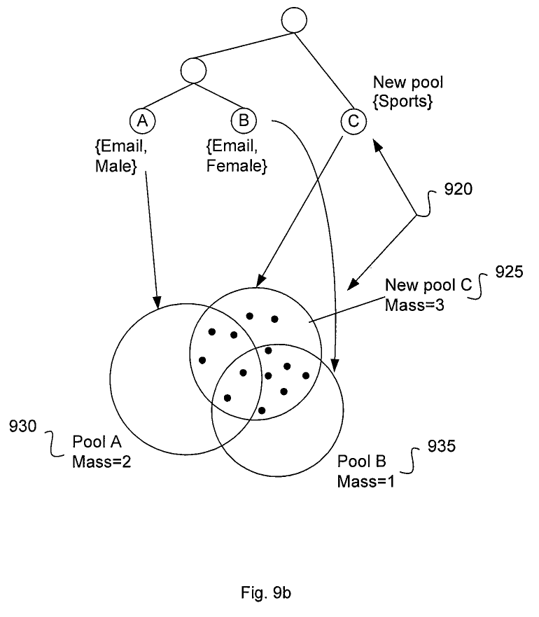

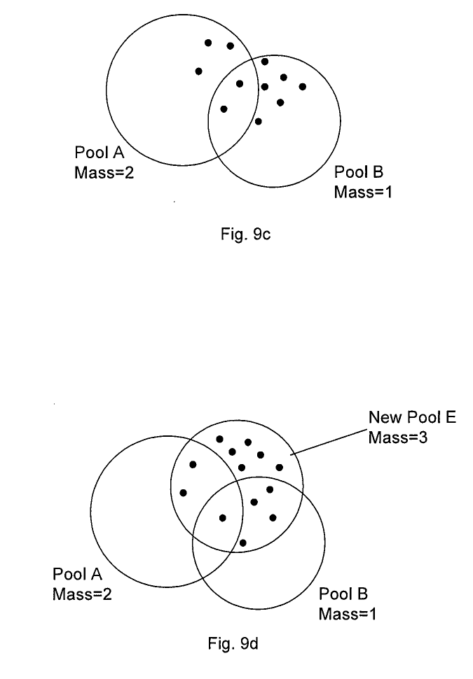

Returning to block 645, if multiple pools do exist, but if at block 650, it is determined that there may be contention between the pools, then a new pool, based on the pools identified, may be generated at block 660, as described with reference to FIG. 9a below, and inventory may be allocated from the new pool at block 665.

FIG. 8 illustrates one way for handling contention between pools. FIG. 8 shows a series of raw pools 810, a CA pool 800, and an Auto pool 805. The CA pool 800 and Auto pool 805 correspond to pools in the pool lattice structure 700 of FIG. 7. The CA pool 800 represents the amount of impression inventory that may be deliverable to Californians, which in this example is 35 Million impressions. The Auto pool 805 represents the amount of impression inventory that may be deliverable to individuals with Automobiles, which in this case is 10 Million impressions. The number of impressions allocated to the CA pool 800 and Auto pool 805 are based on inventory located in the raw pools 810. For example, when determining the amount of available inventory for the CA pool 800, the processor 105 in the system 100 of FIG. 1 may have searched through the raw pool database 120 for pools of impressions delivered to Californians. Similarly, the processor 105 may have searched through the raw pool database 120 for pools of impressions delivered to automobile owners.

It may be the case that a raw pool 815 searched included impressions viewable by Californians with automobiles. This creates a region of contention 820 between the CA pool 800 and the Auto pool 805, which may make it more difficult to keep track of the number of impressions that are available for booking in the two pools. One approach that may alleviate this issue is to distribute the contented impressions between the pools based on the relative mass of the pool, where the mass may be a function of the scarcity of impressions that target a particular audience in that pool, the price of the impressions in the pool, and/or the size of the pool. For example, contented impressions may be given to a pool with fewer impressions so as to increase the number of impressions in that pool.

Application of the approach in the present example results in the creation of a “soft” partition 825 between the CA pool 800 and Auto pool 805 that enables more easily estimating the amount of available inventory in the CA pool 800 and Auto pool 805. For example, if the value of the mass of the CA pool 800 is twice that of the Auto pool 805, then ⅔ of the impressions, or 750,000 impressions, from the raw pool 815 may be allocated to the CA pool 800 and the remaining ⅓ impressions, or 250,000 impressions, may be allocated to the Auto pool 805, as shown in FIG. 8.

This approach may work well when the number of impression ordered in the two pools are relatively small compared to the total size of the pools. For example, if an order specified 10 million California impressions and 2 million Auto impressions, because the CA pool and Auto pool include 34.75 and 9.25 million impressions, respectively, the danger in over allocating impressions is relatively small. If, on the other hand, an order specified 30 million California impressions and 8 million automobile impressions, or an order specified some number of impressions that are viewable by Californian's with automobiles, the risk of over allocating, or allocating impressions which do not actually exist, increases. In such cases, a new pool may be added to the pool lattice structure 700 of FIG. 7 as described below.

FIG. 9a is a flow diagram of operations for adding a new pool into the pool lattice structure 700 of FIG. 7. In block 900, samples of impression that include the impression attributes of the new pool are taken from raw pools of impression inventory. Each sample represents a number of impressions. For example, if the total available inventory of impressions with attribute X is 1 million, and 100 samples are taken, then each sample corresponds to 1 million/100, or 10,000 impressions.

At block 905, sampled impressions that fall into one or more existing pools in the pool lattice structure are located. For example, in FIG. 9b, the impressions samples all fall within the pool C 925, which in this case corresponds to a new pool that represents impressions that are deliverable to sports enthusiasts. Some of the samples taken also fall within pool A 930 and pool B 935. Pool A 930 and pool B 935 represent impressions viewable by males and females, respectively, via an email web page. In this case, the located pools correspond to pool A 930 and pool B 935 as those two pools include some of the samples.

At block 910, a number of impressions proportional to the number of samples in each pool is removed. For example, referring to FIG. 9c, assuming each sample corresponds to 10,000 or 10k impressions, the number of impressions removed from pool A 930 and pool B 935 correspond to the following equations, respectively:

$${I}_{A\_removed} = {S}_{A} \times 10 k + {S}_{AB} \times \frac{{M}_{A}}{{M}_{A} + {M}_{B}} \times 10 k$$

$${I}_{B\_removed} = {S}_{B} \times 10 k + {S}_{AB} \times \frac{{M}_{B}}{{M}_{A} + {M}_{B}} \times 10 k$$

where S_{A} and S_{B} correspond to the 3 samples and 6 samples that are only in pool A 930 and pool B 935, respectively, SAB corresponds to the 2 samples that are shared between pool A 930 and pool B 935, and M_{A} and M_{B} correspond to the relative masses of pool A 930 and pool B 935, respectively. The right hand side of each expression accounts for the number of impressions that would have been allocated to the respective pools via the soft partitioning described above. That is, through soft partitioning, the impressions represented by the 2 samples in the shared region would have been previously allocated between pool A 930 and pool B 935 based on the relative mass of the pools.

Referring back to FIG. 9a, at block 915, the impressions removed from the located pools are redistributed between the new pool and the located pools. This is illustrated in FIG. 9d in terms of samples, where after redistribution, pool A 930 and pool B 935 have fewer samples than before and pool C 925 has more samples. If each sample corresponds to 10k impressions then the number of impressions redistributed back to the respective pools is expressed by the following equations, respectively:

$${I}_{A\_inserted} = {S}_{A} \times 10 k \times \frac{{M}_{A}}{{M}_{A} + {M}_{C}} + {S}_{AB} \times \frac{{M}_{A}}{{M}_{A} + {M}_{B} + {M}_{C}} \times 10 k$$

$${I}_{B\_inserted} = {S}_{B} \times 10 k \times \frac{{M}_{B}}{{M}_{B} + {M}_{C}} + {S}_{AB} \times \frac{{M}_{B}}{{M}_{A} + {M}_{B} + {M}_{C}} \times 10 k$$

$${I}_{C\_inserted} = {S}_{C} \times 10 k + {S}_{A} \times 10 k \times \frac{{M}_{C}}{{M}_{A} + {M}_{C}} + {S}_{AB} \times \frac{{M}_{C}}{{M}_{A} + {M}_{B} + {M}_{C}} \times 10 k + {S}_{B} \times \frac{{M}_{C}}{{M}_{B} + {M}_{C}} \times 10 k$$

By performing the redistribution on the basis of samples rather than actual impressions, an approximate number of impressions in the new pool may be determined quickly.

The operations described above enable quickly determining and allocating impressions for a contract order that targets an audience defined by parameters that are not readily represented in the pool lattice structure. In other words, when a contract order that specifies an audience that is not well represented in the lattice structure arrives, a new pool that represents impressions deliverable to that target audience may be generated in a relatively short time. This in turn enables quickly booking the impressions. In the example above, only three pools are utilized. However, the equations may be modified so as to deal with an arbitrary number of pools.

FIG. 10a is a flow diagram of operations for generating a set of representatives that represent impression inventory from which impressions are allocated. A representative is analogous to an actual Internet user that may view an advertisement. Each representative fully specifies attributes associated with the user it is intended to represent. For example, the representative may include biographic information, such as the user's age and gender. The user information may also include demographic information, such as the state, city and zip code where the user lives. Other attributes, such as the user's hobbies may be specified. In addition to the user attributes, each representative also includes the property or properties along with advertisement positions associated with advertisements that the user has viewed. For example, the property may correspond to a search engine and/or email web page where the advertisement was placed, such as Yahoo! Search® and Yahoo! Mail®, respectively. The position may correspond to the place on the web page where the advertisement was located, such as the top, bottom, and/or side of the web page. Each representative may also include a weight attribute. The weight attribute corresponds to the number of actual user the representative represents. For example, 1 million representative samples may be generated from 50 million users. In this case, the weight of each representative may correspond to the number of samples divided by the total number of users, or 50.

At block 1000, a set of representative samples may be generated. Representatives are generated by identifying all the pools to which a specific impression may belong. For example, 1 million representatives may be generated from impressions in raw pools and may be defined by the parameters that define each raw pool to which the impression belongs. For example, a given impression may belong to a pool of male impressions, a pool of users of age 18, a pool of users that like sports, and a pool of users that live in Los Angeles, Calif. In this case, the representative may be utilized to represent 18 year old males who live in Los Angeles Calif., who are sports enthusiasts.

At block 1005, an order for purchasing a number of impressions that target a specified audience may be received. For example, an advertiser, via a web page generated by the admission control subsystem 110 of FIG. 1, may specify that he wishes to target 1 million male impressions in California.

At block 1010, the amount of available inventory is determined. The total amount of available inventory corresponds to the sum of the weights of representatives that have attributes that match the impressions attributes specified in the contract order, less the amount of inventory that has already been allocated from each representative. For example, if the contract order specifies 1 million California impressions, then the number of impressions available corresponds to the sum of the weights of those representatives that include the attribute California.

At block 1015, an inventory cushion is determined. An inventory cushion corresponds to a number of additional impressions that may need to be allocated so as to guarantee that a contract order may be satisfied. The size of the cushion depends on how likely it is that a contract can be satisfied given the set of available representatives. For example, a contract order that specifies California impressions may require a smaller cushion than the cushion required for a contract order that specifies males of age=5 who live in a specific California zip code, because there are more impressions deliverable to Californians than there are impressions deliverable to males in California of age 5 that live in a specific zip code. The size of the cushion is determined according to the following equations:

$$ɛ = {( \frac{10}{( t μ ( C ) )} )}^{\frac{1}{2}}$$

where ε corresponds to the cushion, t is the number of representative samples, and μ(C) corresponds to the following equation:

μ(C)=Σ_{x∈C}μ(x)

where μ corresponds to the probability space and μ(x) is the probability that x is sampled. If μ is uniform, then μ(C) corresponds to the fraction of users that are characterized by attributes that satisfy a given contract. This is just one possible equation to determine the cushion size. The cushion size may also be adjusted based on other factors, such as risk tolerance.

Based on the equations above, it may be shown that a contract C with a μ(C)>0.4% may be handled by a 5% cushion, a contract C with a μ(C)>0.025% may be handled by a 20% cushion, and a contract C with a μ(C)>0.004% may be handled by a 50% cushion. Stated differently, a contract that is satisfied by more than 0.4% of the representatives may only require a 5% cushion in the number of impressions allocated, while a contract that may only be satisfied with as few as 0.004% of the representatives may require a 50% cushion in the number of impressions allocated.

At block 1020, if the amount of available inventory is sufficient to satisfy the number of impressions ordered in the contract plus the cushion, then at block 1025, an amount of impressions equal to the sum of the ordered amount and the cushion is allocated across those representatives that are defined by attributes specified in the contract order. If there is not enough inventory, then at block 1030, the advertiser may be notified. The notification may include a number of impressions that is available, so that the advertiser may revise his order accordingly.

This approach enables quick and efficient allocation of available impression inventory. This in turns leads to greater satisfaction on the part of the advertiser who often times would like to book a contract for impressions quickly. However, allocating cushions to each contract may result in an inefficient use of the impression inventory. To address this issue, the cushions associated with contracts may be optimized during off-peak times, such as Sunday at 1 AM. Optimization is described below.

FIG. 10b is a flow diagram for optimizing the cushions associated with the contracts described above. Optimization is utilized to determine a more accurate value of a cushion associated with the contract. The operations described by the flow diagram may be performed by a processor, such as the processor 105 of FIG. 1, on a periodic basis, such as every night at 1 AM.

At block 1030, a non-optimized contract may be retrieved. The non-optimized contract corresponds to a contract between the advertiser and the system operator generated via the flow diagram of FIG. 10a. The contracts may have been previously stored in the contract database 115 of FIG. 1 or a different database.

At block 1035, the actual representativeness of the attributes in the contract may be determined. The actual representativeness is determined by computing the sum of all the available impressions, rather than a representative sample, that include attributes that match the attributes specified in the contract. This actual representativeness is more accurate, because it is determined based on the entire available inventory rather than a sample of the available inventory, as described above in FIG. 10a. However, determining the actual representativeness may take a relatively long time when compared to determining the representativeness based on samples. For this reason, the operations of FIG. 10b may be performed offline or in the background, so as to not delay the generation of the contract between the advertiser and the web site operator. Once the actual representativeness is determined, a more accurate value for the cushion is determined.

At block 1040, if the actual representativeness indicates that the cushion associated with the contract should be adjusted, then the cushion of impressions allocated to the contract may be increased or decreased accordingly at block 1045. For example, if it is determined that the cushion associated with a contract is unnecessarily high, the cushion of impressions associated with the contract may be reduced. On the other hand, if the cushion is too small then the cushion may be increased. If the cushion is adequate, then it may remain unchanged.

At block 1050, if there are additional non-optimized contracts, then at block 1055, the next non-optimized contract is retrieved and operations at block 1035 are repeated.

FIG. 11 is a flow diagram of operations for generating a tiered representation of impression inventory. At block 1100, previously generated contract that are problematic may be identified. A problematic contract corresponds to a contract that includes few attributes, but orders a relatively large number of impressions in relation to the number of available impressions. For example, a contract order that specifies 100 million California impressions on a single day may be problematic. The contracts may be located in a database, such as the contract database 115 of FIG. 1 and may be identified by utilizing the processor 105 to search through the contract database 115 for problematic contracts.

At block 1105, a two-tiered pool hierarchy is generated with pools that represent the attributes associated with the problematic contracts identified above in the top tier, and fine grain pools in the second tier that are defined by many attributes.

FIG. 12 illustrates the two-tiered hierarchy. As shown, the top-tier pools 1200 represents pools of impressions defined by relatively few attributes. For example, one pool may group impressions from males in California that view advertisements via email. Another pool may group impressions from females in California that view advertisements via email. The bottom-tier pools 1205 include pools with many attributes. For example, one bottom-tier pools may represent impression that are deliverable to females of age 15 who live within a specific zip code in California that view advertisements that are on the left side of an email web page.

FIG. 13 is a flow diagram for allocating impressions from the two-tiered pool hierarchy generated above. At block 1300, a contract order may be received. For example, a web page for purchasing impressions may be generated by the admission control subsystem 110 of FIG. 1 and communicated to the advertiser. The advertiser may then specify a target audience.

At block 1302, top tier pools that may be capable of satisfying a contract order are located.

At block 1305, for each located top tier pool, if the contract can be entirely satisfied at the top-tier, then at block 1310, the impression inventory for the contract is allocated from the top tiers. For example, referring to FIG. 12, if a contract order only specifies the attributes males from California that view advertisements via email, then impression allocations may be made entirely from a corresponding top-tier pool 1210.

At block 1315, in some embodiments, the impressions allocated from the top-tier pool may be distributed across one or more bottom-tier pools. This may occur during off peak hours. The impressions may be allocated in different ways. For example, the impressions may be randomly distributed across bottom-tier pools that are represented by the top-tier pool. The impressions may also be evenly across bottom-tier pools. A combination of the two approaches may also be utilized. That is, the impressions may be randomly distributed across some bottom-tier pools and evenly distributed among other bottom-tier pools. The impressions may also be distributed according to a distribution plan. For example, the distribution plan may specify that impressions from a top-tier pool are to be allocated predominately to associated bottom-tier pools that represent males. Alternatively or in addition, the distribution plan may specify that the impressions are to be allocated to the least expensive associated bottom-tier pools.

In other embodiments, the operations at block 1315 may not occur until advertisements associated with the contract are actually served.

Returning to block 1305, if the contract cannot be entirely satisfied at the top-tier, then at block 1320, the impression inventory for the contract may be allocated from the bottom-tier pools. The impressions may be distributed across the bottom-tier pools as described above.

Via the operations above, the impressions for a contract may be allocated to top tier pools, bottom tier pools, or some combination of top and bottom tier pools. For example, one top tier pool may totally satisfy the targeting requirements of a contract, but may not represent enough impressions. In this case, some of the impressions may be allocated to the top tier pool and the rest may be allocated from bottom tier pools unrelated to the top tier pool, but that nonetheless represent impressions that may satisfy the contract request.

In other instances, it may be the case that a top tier pool totally satisfies the targeting requirements of a contract and may represent a number of impressions capable of satisfying the contract. However, so as to provide better representativeness, the impressions allocated may still be distributed between some top tier pools and bottom tier pools unrelated to the top tier. For example, suppose the contract requested impressions that represent females. Referring to FIG. 12, this contract request may be totally satisfied via the pool “Email, CA, Female.” However, the impressions in this pool represent females in California, not females from across the country. The advertiser specifying the contract request may intend that the impressions be distributed across the country. To provide a more distributed allocation, the impressions allocated may partly come from the top-tier node “Email, CA, Female,” and partly from bottom-tier nodes unrelated to the top-tier pool above, but that nonetheless represent females.

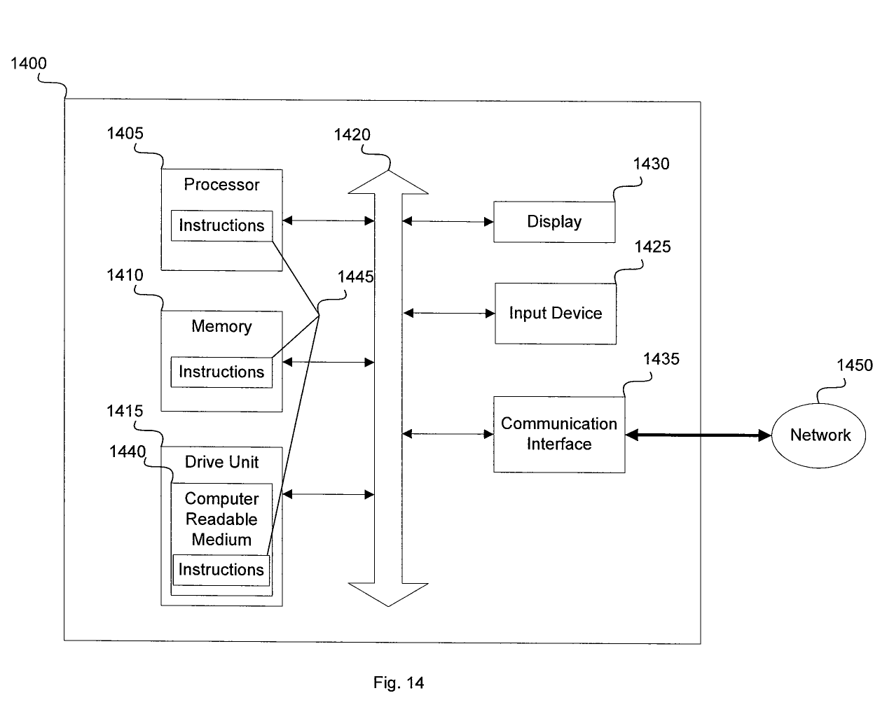

FIG. 14 illustrates a general computer system 1400, which may represent the processor 105 of FIG. 1, or any of the other computing devices referenced herein. The computer system 1400 may include a set of instructions 1445 that may be executed to cause the computer system 1400 to perform any one or more of the methods or computer-based functions disclosed herein. The computer system 1400 may operate as a stand-alone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 1400 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 1445 (sequential or otherwise) that specify actions to be taken by that machine. In one embodiment, the computer system 1400 may be implemented using electronic devices that provide voice, video or data communication. Further, while a single computer system 1400 may be illustrated, the term “system” shall also be taken to include any collection of systems or sub-systems that individually or jointly execute a set, or multiple sets, of instructions to perform one or more computer functions.

As illustrated in FIG. 14, the computer system 1400 may include a processor 1405, such as a central processing unit (CPU), a graphics processing unit (GPU), or both. The processor 1405 may be a component in a variety of systems. For example, the processor 1405 may be part of a standard personal computer or a workstation. The processor 1405 may be one or more general processors, digital signal processors, application specific integrated circuits, field programmable gate arrays, servers, networks, digital circuits, analog circuits, combinations thereof, or other now known or later-developed devices for analyzing and processing data. The processor 1405 may implement a software program, such as code generated manually (i.e., programmed).

The computer system 1400 may include a memory 1410 that can communicate via a bus 1420. For example, contract database 115, raw pool database 120, and/or structure pool database 125 of FIG. 1 may be stored in the memory. The memory 1410 may be a main memory, a static memory, or a dynamic memory. The memory 1410 may include, but may not be limited to, computer readable storage media such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one case, the memory 1410 may include a cache or random access memory for the processor 1405. Alternatively or in addition, the memory 1410 may be separate from the processor 1405, such as a cache memory of a processor, the system memory, or other memory. The memory 1410 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 1410 may be operable to store instructions 1445 executable by the processor 1405. The functions, acts or tasks illustrated in the figures or described herein may be performed by the programmed processor 1405 executing the instructions 1445 stored in the memory 1410. The functions, acts or tasks may be independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 1400 may further include a display 1430, such as a liquid crystal display (LCD), an organic light emitting diode (OLED), a flat panel display, a solid state display, a cathode ray tube (CRT), a projector, a printer or other now known or later-developed display device for outputting determined information. The display 1430 may act as an interface for the user to see the functioning of the processor 1405, or specifically as an interface with the software stored in the memory 1410 or in the drive unit 1415.

Additionally, the computer system 1400 may include an input device 1425 configured to allow a user to interact with any of the components of system 1400. The input device 1425 may be a number pad, a keyboard, or a cursor control device, such as a mouse, or a joystick, touch screen display, remote control or any other device operative to interact with the system 1400.

The computer system 1400 may also include a disk or optical drive unit 1415. The disk drive unit 1415 may include a computer-readable medium 1440 in which one or more sets of instructions 1445, e.g. software, can be embedded. Further, the instructions 1445 may perform one or more of the methods or logic as described herein. The instructions 1445 may reside completely, or at least partially, within the memory 1410 and/or within the processor 1405 during execution by the computer system 1400. The memory 1410 and the processor 1405 also may include computer-readable media as discussed above.

The present disclosure contemplates a computer-readable medium 1440 that includes instructions 1445 or receives and executes instructions 1445 responsive to a propagated signal, so that a device connected to a network 1450 may communicate voice, video, audio, images or any other data over the network 1450. The instructions 1445 may be implemented with hardware, software and/or firmware, or any combination thereof. Further, the instructions 1445 may be transmitted or received over the network 1450 via a communication interface 1435. The communication interface 1435 may be a part of the processor 1405 or may be a separate component. The communication interface 1435 may be created in software or may be a physical connection in hardware. The communication interface 1435 may be configured to connect with a network 1450, external media, the display 1430, or any other components in system 1400, or combinations thereof. The connection with the network 1450 may be a physical connection, such as a wired Ethernet connection or may be established wirelessly as discussed below. Likewise, the additional connections with other components of the system 1400 may be physical connections or may be established wirelessly.

The network 1450 may include wired networks, wireless networks, or combinations thereof. The wireless network may be a cellular telephone network, an 802.11, 802.16, 802.20, or WiMax network. Further, the network 1450 may be a public network, such as the Internet, a private network, such as an intranet, or combinations thereof, and may utilize a variety of networking protocols now available or later developed including, but not limited to, TCP/IP based networking protocols.

The computer-readable medium 1440 may be a single medium, or the computer-readable medium 1440 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 1440 may include a solid-state memory such as a memory card or other package that houses one or more non-volatile read-only memories. The computer-readable medium 1440 also may be a random access memory or other volatile re-writable memory. Additionally, the computer-readable medium 1440 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

Accordingly, the method and system may be realized in hardware, software, or a combination of hardware and software. The method and system may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The method and system may also be embedded in a computer program product, which includes all the features enabling the implementation of the methods described herein and which, when loaded in a computer system, is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the method and system has been described with reference to certain embodiments, it will be understood by those skilled in the art that various changes may be made and equivalents may be substituted without departing from the scope. In addition, many modifications may be made to adapt a particular situation or material to the teachings without departing from its scope. Therefore, it is intended that the present method and system not be limited to the particular embodiment disclosed, but that the method and system include all embodiments falling within the scope of the appended claims.

We claim:

1. A method for allocating inventory in an Internet environment, the method comprising:
generating a first inventory pool, the first inventory pool representing a number of impressions deliverable to all users;
determining, from a plurality of past orders for booking impressions, a hierarchy of parameters utilized to target users and a number of impressions deliverable to users characterized by the parameters;
partitioning the first inventory pool into a plurality of inventory pools according to the hierarchy, where each inventory pool in the plurality of inventory pools represents a number of impressions deliverable to users characterized by a parameter associated with the inventory pool; and
storing the plurality of inventory pools to a database;

2. The method according to claim 1, further comprising:
receiving an order for booking impressions from the plurality of inventory pools, the order including parameters that define an audience and a number of impressions; and
allocating to the order the number of impressions ordered from pools in the database that represent impressions deliverable to users characterized by the parameters in the order.

3. The method according to claim 1, wherein each pool in the database is defined by at least one of: user information, property information, position information, total inventory, and available inventory.

4. The method according to claim 3, wherein the user information characterizes users to whom the inventory is deliverable and includes at least one of: demographic information and geographic information associated with the user.

5. The method according to claim 1, wherein each time inventory is allocated from a pool, an amount corresponding to an amount of inventory allocated is deducted from the available inventory.

6. A method for allocating inventory in an Internet environment, the method comprising:
identifying forecastable inventory pools and unforecastable inventory pools in a plurality of inventory pools, where each inventory pool represents a number of impressions deliverable to users characterized by attributes;
merging each identified unforecastable pool with one or more nearest inventory pools until a combined inventory pool that represents the identified unforecastable pool and the one or more nearest pools is forecastable;
storing the identified forecastable inventory pools and any combined inventory pools to a database;
receiving an order for booking impressions from the pools in the database, the order including parameters that define an audience and a number of impressions; and
allocating to the order the number of impressions from pools in the database that represent impressions deliverable to users characterized by the parameters in the order.

7. The method according to claim 6, further comprising determining an amount of inventory represented by each of the plurality of inventory pools and flagging an inventory pool as unforecastable when the quantity of impressions represented by the inventory pool is below a threshold.

8. The method according to claim 6, further comprising determining a nearness between pools by comparing attributes that define inventory pools, where the more attributes inventory pools share, the nearer the inventory pools are to one another.

9. A machine-readable storage medium having stored thereon, a computer program comprising at least one code section for allocating inventory in an Internet environment, the at least one code section being executable by a machine for causing the machine to perform acts of:
generating a first inventory pool, the first inventory pool representing a number of impressions deliverable to all users;
determining, from a plurality of past orders for booking impressions, a hierarchy of parameters utilized to target users and a number of impressions deliverable to users characterized by the parameters;
partitioning the first inventory pool into a plurality of inventory pools according to the hierarchy, where each inventory pool in the plurality of inventory pools represents a number of impressions deliverable to users characterized by a parameter associated with the inventory pool; and
storing the plurality of inventory pools to a database;

10. The machine-readable storage according to claim 9, wherein the at least one code section comprises code that enables:
receiving an order for booking impressions from the plurality of inventory pools, the order including parameters that define an audience and a number of impressions; and
allocating to the order the number of impressions ordered from pools in the database that represent impressions deliverable to users characterized by the parameters in the order.

11. The machine-readable storage according to claim 9, wherein each pool in the database is defined by at least one of: user information, property information, position information, total inventory, and available inventory.

12. The machine-readable storage according to claim 11, wherein the user information characterizes users to whom the inventory is deliverable and includes at least one of: demographic information and geographic information associated with the user.

13. The machine-readable storage according to claim 9, wherein each time inventory is allocated from a pool, an amount corresponding to an amount of inventory allocated is deducted from the available inventory.

14. A machine-readable storage medium having stored thereon, a computer program comprising at least one code section for allocating inventory in an Internet environment, the at least one code section being executable by a machine for causing the machine to perform acts of:
identifying forecastable inventory pools and unforecastable inventory pools in a plurality of inventory pools, where each inventory pool represents a number of impressions deliverable to users characterized by attributes;
merging each identified unforecastable pool with one or more nearest inventory pools until a combined inventory pool that represents the identified unforecastable pool and the one or more nearest pools is forecastable;
storing the identified forecastable inventory pools and any combined inventory pools to a database;
receiving an order for booking impressions from the pools in the database, the order including parameters that define an audience and a number of impressions; and
allocating to the order the number of impressions from pools in the database that represent impressions deliverable to users characterized by the parameters in the order.

15. The machine-readable storage according to claim 14, wherein the at least one code section comprises code that enables: determining an amount of inventory represented by each of the plurality of inventory pools and flagging an inventory pool as unforecastable when the quantity of impressions represented by the inventory pool is below a threshold.

16. The machine-readable storage according to claim 14, wherein the at least one code section comprises code that enables: determining a nearness between pools by comparing attributes that define inventory pools, where the more attributes inventory pools share, the nearer the inventory pools are to one another.

17. A system for allocating inventory in an Internet environment, the system comprising:
a processor operable to generate a first inventory pool, the first inventory pool representing a number of impressions deliverable to all users; determine, from a plurality of past orders for booking impressions, a hierarchy of parameters utilized to target users and a number of impressions deliverable to users characterized by the parameters; partition the first inventory pool into a plurality of inventory pools according to the hierarchy, where each inventory pool in the plurality of inventory pools represents a number of impressions deliverable to users characterized by a parameter associated with the inventory pool; and store the plurality of inventory pools to a database;

18. The system according to claim 17, further comprising:
an admission control subsystem operable to receive an order for booking impressions from the plurality of inventory pools, the order including parameters that define an audience and a number of impressions; and allocate to the order the number of impressions ordered from pools in the database that represent impressions deliverable to users characterized by the parameters in the order.

19. The system according to claim 17, wherein each pool in the database is defined by at least one of: user information, property information, position information, total inventory, and available inventory.

20. The system according to claim 19, wherein the user information characterizes users to whom the inventory is deliverable and includes at least one of: demographic information and geographic information associated with the user.

21. The system according to claim 17, wherein each time inventory is allocated from a pool, an amount corresponding to an amount of inventory allocated is deducted from the available inventory.

22. A system for allocating inventory in an Internet environment, the system comprising:
a processor operable to identify forecastable inventory pools and unforecastable inventory pools in a plurality of inventory pools, where each inventory pool represents a number of impressions deliverable to users characterized by attributes; merge each identified unforecastable pool with one or more nearest inventory pools until a combined inventory pool that represents the identified unforecastable pool and the one or more nearest pools is forecastable; store the identified forecastable inventory pools and any combined inventory pools to a database; and
an admission control subsystem operable to receive an order for booking impressions from the pools in the database, the order including parameters that define an audience and a number of impressions; and allocate to the order the number of impressions from pools in the database that represent impressions deliverable to users characterized by the parameters in the order.

23. The system according to claim 22, wherein the processor is further operable to determine an amount of inventory represented by each of the plurality of inventory pools and flagging an inventory pool as unforecastable when the quantity of impressions represented by the inventory pool is below a threshold.

24. The system according to claim 22, wherein the processor is further operable to determine a nearness between pools by comparing attributes that define inventory pools, where the more attributes inventory pools share, the nearer the inventory pools are to one another.
